(19) United States
(12) Patent Application Publication
(10) Pub. No.: US 2011/0093305 A1
(43) Pub. Date: Apr. 21, 2011

(54) SYSTEMS AND METHODS FOR FUELING MANAGEMENT

(76) Inventors: Tom Alexander, Andover, MA (US); Paul Grosshart, Hanson, MA (US); James C. Cross, III, Carlisle, MA (US)

(21) Appl. No.: 12/907,896

(22) Filed: Oct. 19, 2010

Related U.S. Application Data
(60) Provisional application No. 61/253,010, filed on Oct. 19, 2009.

(51) Int. Cl. G06Q 10/00

(52) U.S. Cl. 705/7.13

(57) ABSTRACT

Systems and methods for determining and administering a refueling schedule for a fleet of one or more hydrogen-consuming vehicles, and managing hydrogen production rates and inventory levels servicing such vehicles. In certain embodiments, the disclosed systems and methods relate to determining when a vehicle may use a refueling station. The disclosed systems and methods also relate to controlling the rate and schedule according to which hydrogen is produced by one or more hydrogen generation plants available to the vehicle fleet, based upon the fuel inventories, consumption rates and/or refueling patterns of the fleet.

This application claims priority to U.S. Provisional Application No. 61/253,010, filed Oct. 19, 2009, which is incorporated by reference in its entirety.

In a typical warehouse environment several forklift trucks may attempt to refuel at once, for example, at the end of a shift, the beginning of a shift, or after a lunch break. For a single refueling point, a group or fleet of 15 trucks, and a 4-5 minute refueling time, this could lead to wait times for refueling exceeding one hour and cause a significant loss of fleet productivity.

This disclosure provides systems and methods for determining and administering a refueling schedule for a fleet of one or more hydrogen-consuming vehicles, and managing hydrogen production rates and inventory levels servicing such vehicles. The only similarity required amongst the vehicles of a fleet is that each be a hydrogen-consuming vehicle. Examples of such hydrogen-consuming vehicles include, for example, forklifts, transit or shuttle buses, taxis, trucks including those with H₂₋powered auxiliary power units, passenger vehicles, etc. In certain embodiments, the disclosed systems and methods relate to determining when a vehicle may use a refueling station. This determination can minimize or eliminate the need to wait for other vehicles in the group or fleet to complete refueling (so-called “opportunistic refueling”), can be made according to hydrogen availability (to avoid underfills), and/or can be made to allow enough time to refuel in various environmental conditions. The disclosed systems and methods also relate to controlling the rate and schedule according to which hydrogen is produced by one or more hydrogen generation plants available to the vehicle fleet, based upon the fuel inventories, consumption rates and/or refueling patterns of the fleet.

The systems and methods provided in this disclosure can be used to provide information to operators and managers of a hydrogen based fleet of vehicles, notifying them of preferred or optimal times to refuel. This disclosure can also provide methods to use information gathered about the refueling schedule to control the rate and schedule of hydrogen production from a hydrogen generation plant.

In particular, and in one embodiment, a system is disclosed for managing hydrogen fueling of a fleet of vehicles, comprising: a wireless network; a central processor; a fleet of hydrogen-consuming vehicles; one or more fueling stations available to the fleet of vehicles; and one or more hydrogen generation plants; wherein the central processor (i) collects data from each vehicle in the fleet of vehicles, (ii) collects data from one or more hydrogen fueling stations available to the fleet, (iii) calculates a fuel benefit criterion or urgency for each vehicle in the fleet, (iv) identifies and ranks vehicles in the fleet according to the fueling benefit criterion or urgency, and (v) notifies vehicles in the fleet of refueling opportunities according to ranking. Additionally, in another embodiment a method is disclosed for managing hydrogen fueling of a fleet of vehicles, the method comprising: collecting data from each vehicle in the fleet of vehicles; collecting data from one or more hydrogen fueling stations available to the fleet; calculating a fuel benefit criterion or urgency for each vehicle in the fleet; identifying and ranking vehicles in the fleet according to the fueling benefit criterion or urgency; and notifying vehicles in the fleet of refueling opportunities according to ranking.

### BRIEF DESCRIPTION OF THE DRAWINGS

FIG. 1 is a depiction of the communication paths for an embodiment of the invention.

FIG. 2 is a flow chart of a communication process between a vehicle and a central processor

FIG. 3 is a graph depicting the remaining operation time for each vehicle in a hypothetical fleet of trucks.

FIG. 4 is a graph showing a comparison of wait times for each truck when opportunistic refueling is used, and when it is not used.

FIG. 5 is a graph showing the cost associated with refueling time.

FIG. 6 is a depiction of an example of a message displayed on a user interface of a vehicle

FIG. 7 is a graphical representation of the evolution of the range limits of the urgency levels

FIG. 8 is a graphical representation of fuel demand forecast over time.

### DETAILED DESCRIPTION

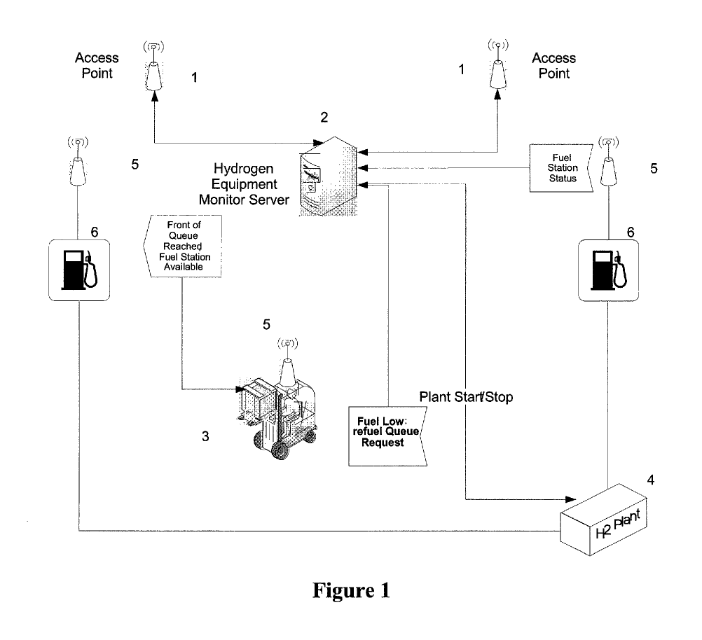

Active fleet management based on intelligent processing of hydrogen station and fleet data can increase productivity by scheduling refueling. Scheduled refueling based on processing of such data is referred to below as opportunistic refueling. FIG. 1 depicts an embodiment of a system according to the invention, including intercommunication paths among vehicle(s) (3), hydrogen fueling station(s) (6), hydrogen generation plant or hydrogen storage (4), and a central processor (2). A vehicle will notify the central processor (2), also known as the server, that refueling is needed. Data can be transmitted between the vehicles (2) (3), the fueling station(s) (6) and the central processor (2) through wireless links, including access points (1) connected to the processor and wireless receivers/transmitters (5) connected to the vehicle(s) and/or the fueling station(s) (6). The central processor (2) can communicate to drivers of the vehicles through wireless links to suggest the best times and locations to refuel and not encounter a wait queue at a refilling station. The central processor (2) will notify the user of the vehicle when the vehicle reaches the top of the queue and the fueling station is available.

Among the information that can be transmitted to a central processor (2), for example a computer or a server, and optionally stored, are the following non limiting examples: the amount of hydrogen on-board each vehicle; the power consumption of each vehicle; the location of each vehicle, including proximity to fueling station dispenser(s); the activity of the hydrogen station(s), i.e. whether a refueling event is presently in process; the amount of hydrogen fuel available at one or more fueling stations; and the current hydrogen generation rate at hydrogen generation plant(s).

In the system illustrated in FIG. 1, the hydrogen generation plant and/or the hydrogen storage (4) supply hydrogen to the hydrogen fueling station(s) (6). As used herein, the capacity of the hydrogen fueling station refers to the availability of hydrogen from the hydrogen generation plant and/or the hydrogen storage (4). Accordingly, the speed of fueling a vehicle (3) is affected by both the ability of the fuel pump to deliver hydrogen fuel as well as the amount of hydrogen available for delivery.

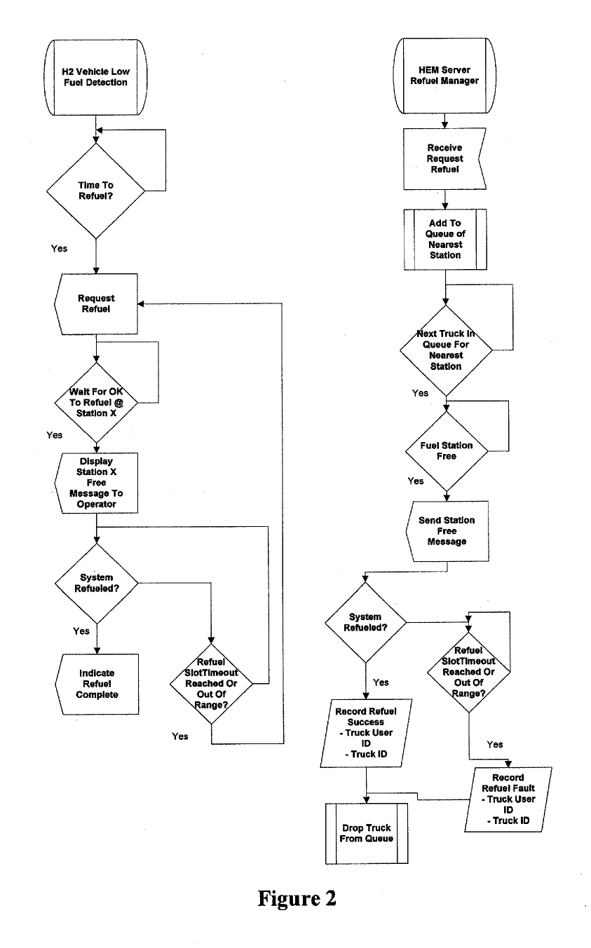

FIG. 2 is an illustration of a communications process/flowchart between a vehicle and the central processor in accordance with a method of the present disclosure.

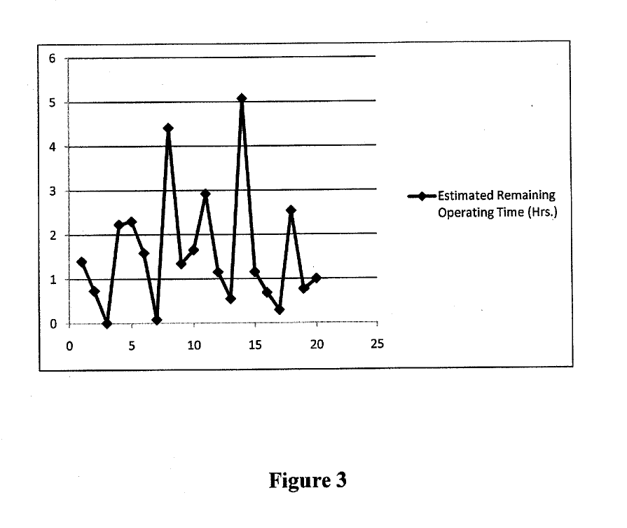

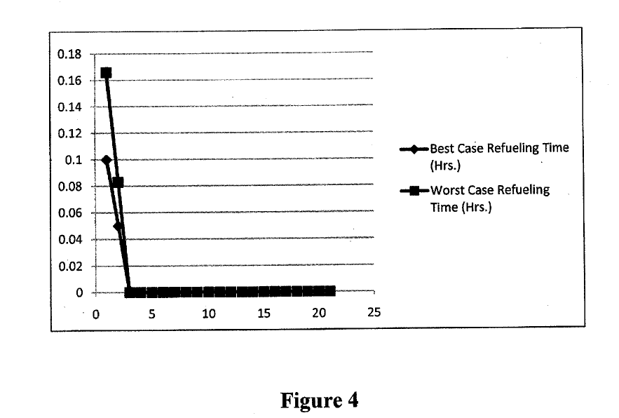

The following equations illustrate one method to estimate remaining operation time of a vehicle. Assuming a rate of fuel consumption ΔH₂, distance from the nearest fuel station dₛₜₐₜᵢₒₙ, and a time constant based upon past operational profiles, T-_{profile}, an estimate of remaining operating time may be given by:

$${T}_{remain} = ( \frac{Δ H 2}{H 2} - {K}_{1} {T}_{profile} ) - {K}_{s} {d}_{station} if ( \frac{Δ H 2}{H 2} > {T}_{profile} )$$

$${T}_{remain} = ( \frac{Δ H 2}{H 2} ) - {K}_{2} {d}_{station} if ( \frac{Δ H 2}{H 2} < {T}_{profile} )$$

where H₂ is the current supply of hydrogen remaining in the vehicle and K₁ and K₂ are coefficients. FIG. 3 is an example of remaining operation time for a hypothetical fleet of 20 vehicles. Assuming that a threshold value of 30 minutes is the minimum time remaining before a refuel notification is given, and assuming only one fuel station is available, the refuel wait time for each vehicle is shown in FIG. 4. As shown in FIG. 4, using opportunistic refueling, the wait times are far lower because multiple trucks will not be attempting to refuel simultaneously. Vehicle IDs with time=0 do not require refueling.

The impact of active fleet management can also be obtained by modeling refueling events, for example, as a Poisson process, in which the times between successive vehicle refueling events follow an exponential probability distribution. Using a Monte-Carlo simulation, statistics of operator experiences of downtime associated with waiting, while another operator completes refueling, can be computed. If the lost time is assigned a monetary value, the costs of random refueling versus managed refueling can be estimated.

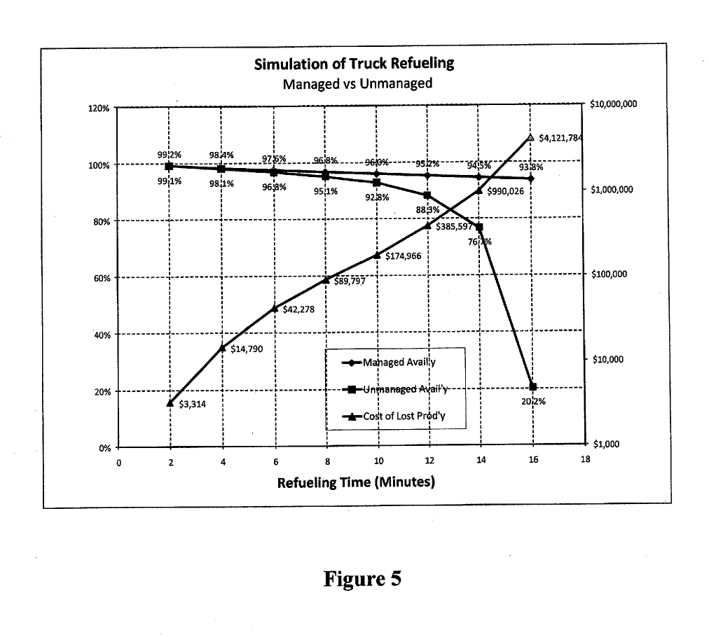

The results of such a simulation are dependent on the time it takes an operator to complete a refueling event. In embodiments involving fuel cell forklift applications, refueling typically takes between 3 minutes (e.g. for a fast-filled steel tank) to 15 minutes (e.g. for a slow-filled composite tank which has a maximum temperature specification that must be abided). The results of the simulation, for a fleet population of 15 vehicles sharing a single refueling station, are shown in FIG. 5.

As can be seen in the comparison of ideal and actual truck availability, the importance of managing the events to avoid lost productivity increases with the time it takes to refuel. Assigning a value of a truck operator's time, e.g. burdened salary (here taken as $40/hour), the cost to the operation can be calculated. For a refuel time of 10 minutes, the annual cost for the studied fleet is ˜$175,000, or about $1,000/month/truck. This calculation is instructive because it forms a basis of a commercial value proposition for the systems and methods disclosed herein.

In one of the methods according to this disclosure, certain metrics and decision criteria need to be elucidated to facilitate encoding of the processor, including: (1) criteria for deciding whether refueling is advantageous, needed, or beneficial on the basis of operating economics; (2) criteria for assigning refueling urgency metrics to vehicles in the fleet; (3) time settings for capturing vehicle fleet and fueling station data; and

(4) countdown timer settings, to enable active and timely queue management.

Regarding the criteria for deciding whether refueling is advantageous, needed, or beneficial, if there is a single vehicle in the fleet, there is no concern about a queue. If the fleet operating capacity is closely matched with the installed fueling capacity, a long queuing time for refueling is likely. Too frequent refuelings incur other productivity losses, for example time lost to transit to and from the station and refueling overheads.

Regarding the criteria for assigning refueling urgency metrics to vehicles, a vehicle that has 5% of its fuel left compared to another that has three times as much, i.e. 15%, may, under some circumstances, be considered to be in more urgent need to be refueled. However, if the consumption rate of the latter vehicle is sufficiently higher than the former, the latter may run out of fuel earlier. Predictors are needed that account for this, and minimize the possibility that a vehicle runs out of fuel before arriving at the refueling station, or incurs productivity loss on account of poorly scheduled refueling.

Regarding time settings for capturing vehicle fleet and fueling station data, managing a fleet involves significant data transfer, storage, and processing. The frequency with which operational data is obtained, and queues updated, should be adaptive.

Regarding the countdown timer settings, once the vehicles that should occupy the top of the queue for each available fueling station are notified accordingly, one has to consider circumstances wherein the request to refuel made to the operator were not abided, either absolutely or in a timely fashion. While the request is not being heeded, the fuel inventories of other vehicles are being depleted, and the longer the time allowed for the top queue operator to respond, the more urgent the situation may become for vehicles next in the queue. The timeout duration must be adaptive and carefully considered.

A snapshot of a fleet comprising 30 trucks serviced by 2 fueling stations is shown in Table 1. The trucks may be of different types (e.g. power ratings, fuel storage sizes, drive speeds, duties they perform, etc), and such defining characteristics may be advantageously used in making forecasts and performing scheduling calculations. In the 6^{th} column of Table 1 is the fuel remaining in each truck's storage tank, as could easily be inferred by pressure measurement (with or without temperature correction). In the 7^{th} column is the average fuel consumption rate, which may be (a) logged on the truck itself, (b) computed using stored data (from e.g. (i) time in active service since the last refueling, (ii) a filter of use data, (iii) a moving average over a time window that captures the truck's essential service characteristics, e.g. 3-5 minutes, and (iv) inference of duty mode using an artificial intelligence system, etc), (c) read from periodically updated learning tables specific to the truck, operator using the truck, or combination of the two, or (d) inferred from a specific dispatch order with known energy duty/signature (e.g. unloading of a delivery truck with a known number of pallets, known pallet weights, and known storage destination of such pallets).

TABLE 1
Snapshot of a fleet operation (30 trucks)

| Truck | Type | Ftank | Tref | Vtruck | Fuel (kg) | Pavg (kg/hr) | Tx (mins) | d1 (m) | d2 (m) |
|---|---|---|---|---|---|---|---|---|---|
| 21 | 1 | 0.75 | 4.81 | 120 | 0.0565 | 0.375 | 9.0 | 119 | 131 |
| 4 | 1 | 0.75 | 4.81 | 120 | 0.0476 | 0.291 | 9.8 | 216 | 34 |
| 26 | 2 | 1.30 | 6.50 | 135 | 0.0433 | 0.235 | 11.1 | 10 | 240 |
| 9 | 2 | 1.30 | 6.50 | 135 | 0.1570 | 0.388 | 24.3 | 174 | 76 |
| 19 | 2 | 1.30 | 6.50 | 135 | 0.0863 | 0.206 | 25.2 | 12 | 238 |
| 16 | 1 | 0.75 | 4.81 | 120 | 0.2045 | 0.387 | 31.7 | 81 | 169 |
| 6 | 3 | 1.10 | 5.88 | 93 | 0.1484 | 0.255 | 34.9 | 63 | 187 |
| 3 | 1 | 0.75 | 4.81 | 120 | 0.3400 | 0.337 | 60.5 | 55 | 195 |
| 1 | 1 | 0.75 | 4.81 | 120 | 0.3001 | 0.250 | 71.9 | 122 | 128 |
| 13 | 3 | 1.10 | 5.88 | 93 | 0.4670 | 0.374 | 74.9 | 42 | 208 |
| 8 | 3 | 1.10 | 5.88 | 93 | 0.3333 | 0.238 | 83.9 | 42 | 208 |
| 14 | 1 | 0.75 | 4.81 | 120 | 0.4141 | 0.293 | 84.8 | 104 | 146 |
| 10 | 1 | 0.75 | 4.81 | 120 | 0.6610 | 0.396 | 100.2 | 236 | 14 |
| 15 | 2 | 1.30 | 6.50 | 135 | 0.4951 | 0.297 | 100.0 | 111 | 139 |
| 11 | 1 | 0.75 | 4.81 | 120 | 0.5247 | 0.300 | 104.9 | 197 | 53 |
| 27 | 3 | 1.10 | 5.88 | 93 | 0.4328 | 0.226 | 114.8 | 76 | 174 |
| 22 | 3 | 1.10 | 5.88 | 93 | 0.1877 | 0.093 | 121.5 | 41 | 209 |
| 23 | 3 | 1.10 | 5.88 | 93 | 0.5883 | 0.238 | 148.6 | 94 | 156 |
| 29 | 2 | 1.30 | 6.50 | 135 | 0.8286 | 0.313 | 158.6 | 33 | 217 |
| 30 | 3 | 1.10 | 5.88 | 93 | 0.3211 | 0.111 | 173.6 | 30 | 220 |
| 17 | 2 | 1.30 | 6.50 | 135 | 0.9433 | 0.268 | 211.5 | 39 | 211 |
| 5 | 3 | 1.10 | 5.88 | 93 | 0.8634 | 0.227 | 228.3 | 224 | 26 |
| 7 | 2 | 1.30 | 6.50 | 135 | 0.9973 | 0.260 | 230.2 | 186 | 64 |
| 18 | 3 | 1.10 | 5.88 | 93 | 0.9285 | 0.224 | 248.5 | 78 | 172 |
| 2 | 1 | 0.75 | 4.81 | 120 | 0.5035 | 0.119 | 254.4 | 243 | 7 |
| 20 | 3 | 1.10 | 5.88 | 93 | 0.6236 | 0.142 | 264.4 | 66 | 184 |
| 24 | 1 | 0.75 | 4.81 | 120 | 0.3783 | 0.069 | 329.6 | 138 | 112 |
| 12 | 2 | 1.30 | 6.50 | 135 | 0.6600 | 0.105 | 376.4 | 37 | 213 |
| 28 | 2 | 1.30 | 6.50 | 135 | 0.2104 | 0.033 | 387.6 | 51 | 199 |
| 25 | 3 | 1.10 | 5.88 | 93 | 0.8056 | 0.116 | 417.8 | 219 | 31 |

An indicator of average truck service time remaining before depletion of all on-board fuel (Tx) is given by the fuel inventory divided by the consumption rate. The list in Table 1 has been rank ordered using this refueling “urgency indicator.” In other words, using the tabulated information, the best estimate is that refueling should occur in the order of the list, i.e. truck 21 first, then 4, then 26, etc.

If Truck 21 were working directly adjacent to a fueling station, there was no other truck at that station, and the station had adequate fuel, with Tx=9 minutes one could conclude the operator could work for another 7-8 minutes. However, this does not consider the mounting urgency of the other trucks on the list. Moreover, this does not take into consideration the transit time in the case when the truck is not near a station.

Distances from each truck to each of the two stations are shown in the two rightmost columns. It turns out that Truck 21 is about midway between the two stations, not very close to either one. The transit time to each can be estimated using the tabulated drive speed (which may be encoded, for example, according to the specific truck, operator logged in as user of the truck, historical performance data, or a combination thereof) and known distances to the stations (as determined, for example, by triangulation or GPS). The transit times to stations 1 and 2 for Truck 21 can be estimated to be about 1.0 and 1.1 minutes respectively. So in fact the tabulated Tx value, while indicative, can be refined by additionally including considerations of transit time to stations.

A series of calculations (i.e., iterations) is conducted to assign trucks to queues for each of the available fueling stations. The number of iterations equals the number of trucks in the fleet. The results of the first two iterations are shown in Table 2.

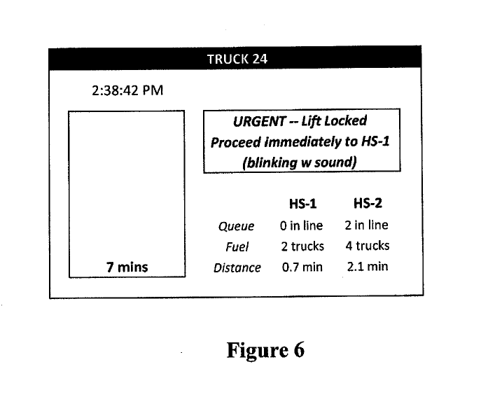

TABLE 2
First two iterations of algorithm for populating the queue

| From FIG. 6 | | | | Iteration 1 | | | | Iteration 2 | | | | QUEUES | |
|---|---|---|---|---|---|---|---|---|---|---|---|---|---|
| Truck | Tx (mins) | d1 (m) | d2 (m) | Tx1(1) | Tx2(1) | Qx(1) | QXR(1) | Tx1(2) | Tx2(2) | Qx(2) | QxR(2) | Station 1 | Station 2 |
| 21 | 9.04 | 119.00 | 131.00 | 8.05 | 7.95 | 7.95 | 1 | | | | | Truck 21 | |
| 4 | 9.81 | 216.17 | 33.83 | 8.01 | 9.53 | 8.01 | 2 | 3.20 | 9.53 | 3.20 | 1 | | Truck 4 |
| 26 | 11.07 | 10.00 | 240.00 | 10.99 | 9.29 | 9.29 | 3 | 6.18 | 9.29 | 6.18 | 2 | | |
| 9 | 24.28 | 173.84 | 76.16 | 22.99 | 23.72 | 22.99 | 4 | 18.19 | 23.72 | 18.19 | 3 | | |
| 19 | 25.17 | 12.00 | 238.00 | 25.08 | 23.41 | 23.41 | 5 | 20.27 | 23.41 | 20.27 | 4 | | |
| 16 | 31.73 | 81.00 | 169.00 | 31.05 | 30.32 | 30.32 | 6 | 26.24 | 30.32 | 26.24 | 5 | | |
| 6 | 34.87 | 63.45 | 186.55 | 34.18 | 32.86 | 32.86 | 7 | 29.38 | 32.86 | 29.38 | 6 | | |
| . . . | . . . | . . . | . . . | . . . | . . . | . . . | . . . | . . . | . . . | . . . | . . . | | |

A quantity Txi(j) is tabulated for each truck, where i is the fueling station number, and j is the number of the iteration. To start the calculation, the seed values are Txi(1)=Tx−di/v where di is the distance of the truck from fueling station i, and v is the drive speed of the truck. Accordingly, Txi(1) is the fuel remaining after the fuel allocation associated with transit to the fueling station is subtracted.

Another parameter is Qx(j), where j is the iteration. The Qx indicator is the criterion on which relative refueling urgency is predicted, and can be defined in a variety of ways according to the nuances of the specific application. In general one could consider a class of functions Qx(j)=f(Txi(j)). In the example tabulated in Table 2, Qx(j)=min(Txi(j)) over i=1, 2. The basis of this assignment is the case where the more proximate refueler becomes unexpectedly unavailable, and is therefore conservative. When the Qx(1) values have been computed for all the trucks in the fleet, an order ranking is performed, and this is the entry listed as QxR(j) where j is the iteration.

The first iteration is completed by assignment of the truck with the highest refueling urgency according to the described method to the queue of the station to which it is most proximate, e.g. truck 21 has QxR(1)=1, and is closer to station 1 (d1=199<d2=131), thus on the right side truck 21 is entered into the Station 1 queue. This truck is then considered removed from the active list, i.e., will not be considered in subsequent iterations.

The algorithm is more fully revealed in the second iteration. The transit time of a truck to reach a station has already been accounted in the first iteration. But now that a truck has been placed into the queue (truck 21 in the queue of station 1), any other trucks considered for refueling at this station, to avoid waiting in line, must have an additional reserve of fuel corresponding to the refueling time allocated to the truck (listed in Column 4 of Table 1) placed in the queue in the prior iteration. Thus, Tx1(2)=Tx1(1)−Tref(Truck 21) while Tx2(2)=Tx2(1). Once all Txi(2) values have been tabulated, the Qx(2) metric is computed, the QxR(2) rank ordering performed, and the next queue assignment made, as in the first iteration. The truck so placed in a queue (in this 2^{nd} iteration, Truck 4 is placed into the top spot of the queue for Station 2) is then again removed from the active list. Subsequent iterations follow the method of the second, until all iterations have been completed, and all trucks placed into queues.

It is not always the case that all stations have adequate fuel for all trucks assigned, and at the times that they will require fuel. Thus, another embodiment of the method may consider the inventory of fuel at each station during the execution of the algorithm, and how it can change or actively be managed with time. This can be addressed by removing a station from consideration for a particular iteration if it will not or cannot have the required fuel at the predicted time it will be needed.

The vehicles in the fleet are behaving (consuming fuel) according to real-time operator decisions, ostensibly influenced by dispatcher instructions. For generality and the widest applicability, one may consider that the processes have a highly stochastic character. Under such a scenario, the import of the queue populated above will erode over time—some trucks will hasten their fuel consumption while others will reduce, leading to a mixing up of the actual urgencies. Consequently, a timeframe for updating the queues (the operation “forecast”) may be rationalized and implemented.

Updating the queues as frequently as possible may lead to confusion and conflicting instructions being sent to operators, e.g. one truck may be indicated it is 3rd in the queue, then 4^{th}, then 2^{nd}, then 5^{th}, etc. in successive updates. This would be annoying and distracting to operators if it were happening too frequently. Thus, there is a human interfaces tradeoff that must be balanced when determining the frequency with which the queues should be updated.

Updating may be periodic with a fixed timescale. Such timescale may be dictated by the communications and informational infrastructure selected for the operation, e.g. full queue updating every 45 seconds.

Other possibilities are that the timescale between updates be adjusted according to (i) the aggregate refueling urgency or lack thereof, (ii) an index characteristic of the variability of fuel consumption on select or on all vehicles in the fleet, (iii) a specific time period, e.g., time of day, or (iv) the number of trucks in service.

Criteria are also needed for the processor to decide whether to provide instructions to the operators of the trucks in the queue and, if so, what to instruct them. One scheme is to associate classifications (levels) with ranges of fuel (time such as Tx) remaining. An example of classifications for vehicles at the top of a queue is shown in Table 3.

TABLE 3
Urgency Level Definition Table for Top of Queue

| Tx (mins) | Level | Action |
|---|---|---|
| >60 | 1 | Message: no need to refuel |
| 30-60 | 2 | Message: composing queue |
| 15-30 | 3 | Directive, audible beep |
| <15 | 4 | Directive 2, lift lockout, continuous audible signal |

Similar tables can be developed for all other vehicles, i.e., those not at the top of a station queue. Classification levels may be defined and then to each discrete level a series of programmatic actions may be mapped that can be executed by the processor, involving (a) sending messages to the vehicles, (b) sending signals that induce actions including, but not limited to alarms, beacons—blinking or continuous lights or combinations lights, lift locks, speed control, automatic steering, voice messages, dispatch intercom, and power off (c) communicating status information to the vehicles (e.g. of station availability or amount of fuel in inventory at station, central clock time, amount of time remaining of truck's fuel or that of other trucks, location in queue, timeout time remaining, etc.) The message sent to the vehicle may include an incentive to refuel, or an incentive to refuel at a particular fueling station. The incentive may include, for example, a discount on fuel, a discount on other items sold at the refueling station, or any other means of encouraging the vehicle operator to refuel.

An example of a user interface display the operator might see is shown in FIG. 6. Such level definitions may be functions that vary in time according to the status of the vehicles, the stations, and the overall operation. It is envisioned that the user interface display may provide a signal indicating when the vehicle is no longer in communication with the central processor because, for example, it is out of range of the wireless network, or because of a failure of the communication network.

A timeout may be defined that provides a window of time the operator has to respond to a directive communicated from the processor to the user interface or other communicating device on the truck, before it is nullified and another order, potentially conflicting, sent out (e.g. to a different truck). The timeout may be a fixed time period, e.g., 30 seconds, or it may be calculated as a function of the queue.

In receiving a notification, the operator can communicate, by pressing a button or touch screen, speech, keypad entry, or other means of acknowledgment and intention to comply with the directive. Alternatively, connection to refueler may be electronically confirmed, or locational tracking may be engaged to infer whether or not the operator is complying, for example, by confirming that the distance from truck to refueling station is decreasing. Absent these inputs a timeout must be selected to nullify the previous notification, and either regenerate it to the same truck or move on to another with urgency.

The timeout timescale can be made a function of the updating timescale. For example, it can be one half of or the same as the update timescale. More elaborate methods of assigning a timeout value are envisioned, e.g. based on timescales inferred from temporal analysis of the queue and potential clustering events, or “traffic”.

Once the queue is populated, a temporal analysis of the queue is conducted. The method is described graphically but can be implemented and coded relatively easily with simple search algorithms. Each queue is represented as a timeline (increasing to the right), with points placed upon it representing the Tx values for all the trucks in that queue. The refueling time requirement (Tref) for each truck in the queue is shown as a bar in Table 4, with its starting time at the left edge. Overlap of bars represents “traffic.” The bars must be spread so as to avoid refueling interferences. An algorithm is performed to “sequence the bars” so that they are adjacent but do not overlap. A search is then done to calculate the maximum duration Tmax of connected bars. These are the series of refuelings that must be managed most aggressively and carefully.

TABLE 4
Identification of Potential Traffic

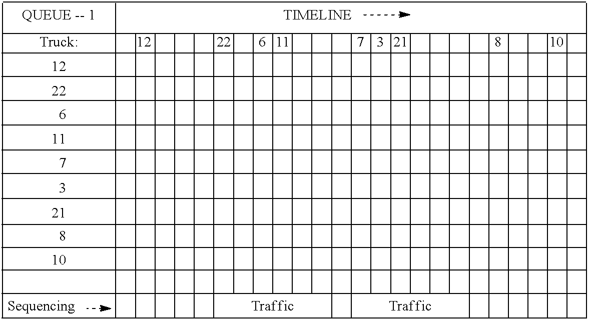

The queue may evolve and the traffic may dissipate, or it may intensify. To handle these situations the management system may be flexible and adjust its definition of what is urgent. For example, Truck 22 in Table 4, which leads the first traffic cluster, if subject to the same urgency criteria as Truck 12 (which is isolated), may lead to backups and waiting at the station for subsequent trucks (6 and/or 11). This situation may be anticipated and managed; specifically the level classifications may be modified as these situations arise.

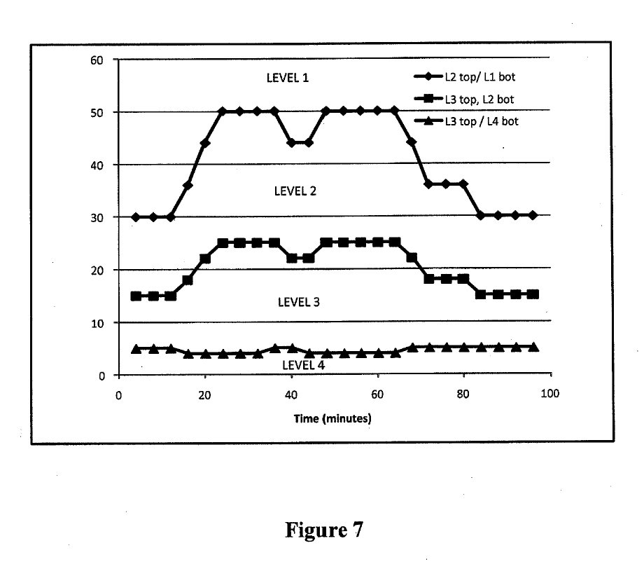

For example, if default practice is to send urgent notification when Tx less than a certain value, In the case of traffic, e.g. the 3-truck cluster (22,6,11), the practice may be modified temporarily by sending urgent notifications when Tx is less than a value greater than Y. An example of evolving limits defining the urgency levels with time is shown in Table 5 and in FIG. 7. Thus, a classification scheme that evolves with the queue is conceived—an example is shown in FIG. 7—the limits defining the ranges constituting different levels are adjusted to ensure efficient processing of the trucks in the refueling order.

TABLE 5
Level range modification through temporal processing of the queue
Level Evolution with the Queue

| | Time (mins) = | | | | | | | | | | | | | | | | | | | | | | | |
|---|---|---|---|---|---|---|---|---|---|---|---|---|---|---|---|---|---|---|---|---|---|---|---|---|
| | 4 | 8 | 12 | 16 | 20 | 24 | 28 | 32 | 36 | 40 | 44 | 48 | 52 | 56 | 60 | 64 | 68 | 72 | 76 | 80 | 84 | 88 | 92 | 96 |
| Level 2 top | 30 | 30 | 30 | 36 | 44 | 50 | 50 | 50 | 50 | 44 | 44 | 50 | 50 | 50 | 50 | 50 | 44 | 36 | 36 | 36 | 30 | 30 | 30 | 30 |
| Level 3 top | 15 | 15 | 15 | 18 | 22 | 25 | 25 | 25 | 25 | 22 | 22 | 25 | 25 | 25 | 25 | 25 | 22 | 18 | 18 | 18 | 15 | 15 | 15 | 15 |
| Level 4 top | 5 | 5 | 5 | 4 | 4 | 4 | 4 | 4 | 5 | 5 | 4 | 4 | 4 | 4 | 4 | 4 | 5 | 5 | 5 | 5 | 5 | 5 | 5 | 5 |

i.e. classification of the truck state is based on the amount of fuel remaining, the levels represent different ranges of time windows; windows increase to accommodate traffic,
i.e. scheduling of forward trucks is done earlier to ensure that those following have adequate allowance so as to not run out of fuel.

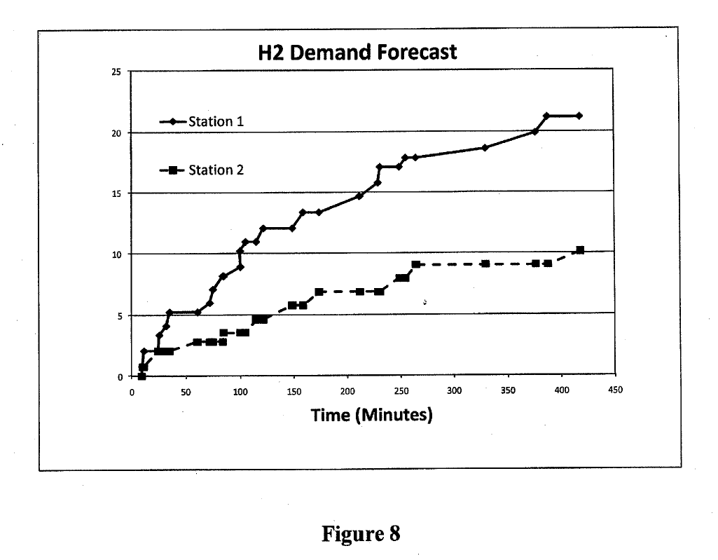

The queues populated in active management create a demand forecast for fuel at each fueling station. Such a forecast is illustrated in FIG. 8. Standard control methods, e.g. Proportional-Integral-Derivative (PID), can be employed to either schedule deliveries of tanked fuel (e.g. liquid or tube trailers) or regulate the output of fuel production appliances to meet demand. These considerations are important in the case of on-site plants for minimizing costs—unmanaged plants which run at full capacity to replenish depleted inventory can saturate storage quicker than needed, leading to the need to vent fuel, go into idle mode, or complete shutdown. Fuel that is disposed is a direct value loss. Startups and shutdowns of plants (which can take hours) incur significant inefficiencies and entail unnecessary costs. Lastly, start/stop cycles are notorious for aggravating plant reliability and durability, thereby entailing additional costs. Intelligent control of the plants, orchestrated with a demand forecast deriving from accumulation and processing of vehicle fleet data can lead to significantly higher operational profitability.

Accumulation of fleet data affords the ability to infer correlations about individual truck duties as functions of parameters, leading to enhanced predictability and optimization of refueling scheduling. For example, activities of trucks or operators or both may be correlated to time of day, day of week, day of the month, season, or other time periods. Statistical analysis of data allows the variability and confidence levels for fuel usage patterns to be more precisely predicted. This can lead to better scheduling of refueling, fuel inventory management, and overall higher operational efficiency and predictability.

A neural network can be conceived for the fleet, with learning parameters according to a vocabulary of operations signals. For example, when a delivery truck arrives, dispatch may send a signal to the truck fleet. Historical data may indicate that certain trucks are used for unloading operations for deliveries of a certain type that may be additionally encoded in the signal. This allows a precise prediction of fuel consumption for certain trucks to be implemented, and inform the algorithms previously described.

What is claimed is:

1. A system for managing hydrogen fueling of a fleet of vehicles, comprising:
a wireless network;
a central processor;
a fleet of hydrogen-consuming vehicles;
one or more fueling stations available to the fleet of vehicles; and
one or more hydrogen generation plants;
wherein the central processor (i) collects data from each vehicle in the fleet of vehicles, (ii) collects data from one or more hydrogen fueling stations available to the fleet, (iii) calculates a fuel benefit criterion or urgency for each vehicle in the fleet, (iv) identifies and ranks vehicles in the fleet according to the fueling benefit criterion or urgency, and (v) notifies vehicles in the fleet of refueling opportunities according to ranking.

2. The system of claim 1, wherein at least one of the following criterion is used to calculate a fuel benefit criterion or urgency:
amount of hydrogen on-board each vehicle;
power consumption of each vehicle;
distance of each vehicle from a fueling station;
amount of hydrogen available or forecast to be available at one or more fueling stations;
current hydrogen generation rate at one or more hydrogen generation plants servicing the one or more hydrogen fueling stations; and
whether a fueling event is presently in process at one or more hydrogen fueling stations.

3. The system of claim 1, wherein multiple iterations are used to calculate the fuel benefit criterion or urgency for each vehicle in the fleet.

4. The system of claim 3, wherein the number of iterations used to calculate the fuel benefit criterion or urgency is based on the number of vehicles in the fleet.

5. The system of claim 1, wherein the central processor periodically recalculates the fuel benefit criterion or urgency for each vehicle in the fleet.

6. The system of claim 1, wherein a notification is sent to a vehicle or vehicle operator of refueling opportunities by at least one signal chosen from an audible alarm; a visible signal; a reduction in vehicle maximum drive; or a lockout or restriction to an operating feature of the vehicle.

7. The system of claim 1, wherein the central processor notifies a vehicle or vehicle operator when refueling is needed.

8. The system of claim 7, wherein the central processor further notifies a vehicle or vehicle operator in need of refueling the status of at least one of the following parameters: time left before the vehicle runs out of hydrogen; an indication of whether the closest refueling station is available or busy; or an indication of the availability of fuel at the closest fueling station.

9. The system of claim 1, wherein the central processor determines whether an operator of a vehicle notified of a refueling opportunity has chosen not to refuel the vehicle.

10. The system of claim 9, wherein the processor recalculates the fuel benefit criterion or urgency for each vehicle in the fleet if the operator of a vehicle that has been notified of a refueling opportunity has chosen not to refuel the vehicle.

11. The system of claim 9, wherein the central processor determines that an operator of a vehicle that has been notified of a refueling opportunity has chosen not to refuel the vehicle when the operator fails to respond to the notification within a fixed time period.

12. The system of claim 9, wherein the central processor determines that an operator of a vehicle that has been notified of a refueling opportunity has chosen not to refuel the vehicle based on the locational tracking information provided by the vehicle.

13. The system of claim 1, wherein the central processor:
calculates a predictor for forecasting hydrogen demand; and
uses the predictor to manage the operating state of the one or more hydrogen plants.

14. A method for managing hydrogen fueling of a fleet of vehicles, the method comprising:
collecting data from each vehicle in the fleet of vehicles;
collecting data from one or more hydrogen fueling stations available to the fleet;
calculating a fuel benefit criterion or urgency for each vehicle in the fleet;
identifying and ranking vehicles in the fleet according to the fueling benefit criterion or urgency; and
notifying vehicles in the fleet of refueling opportunities according to ranking.

15. The method of claim 14, wherein at least one of the following criterion is used to calculate a fuel benefit criterion or urgency:
amount of hydrogen on-board each vehicle;
current power consumption of each vehicle;
distance of each vehicle from a fueling station;
amount of hydrogen available or forecast to be available at one or more fueling stations;
current hydrogen generation rate at one or more hydrogen generation plants servicing the one or more hydrogen fueling stations; and
whether a fueling event is presently in process at one or more hydrogen fueling stations.

16. The method of claim 14, wherein multiple iterations are used to calculate the fuel benefit criterion or urgency for each vehicle in the fleet.

17. The method of claim 16, wherein the number of iterations used to calculate the fuel benefit criterion or urgency is based on the number of vehicles in the fleet.

18. The method of claim 14, further comprising periodically recalculating the fuel benefit criterion or urgency for each vehicle in the fleet.

19. The method of claim 14, wherein vehicles or vehicle operators are notified of refueling opportunities by at least one signal chosen from an audible alarm; a visible signal; a reduction in vehicle maximum drive; or a lockout or restriction to an operating feature of the vehicle.

20. The method of claim 14, wherein vehicles or vehicle operators are notified when refueling is needed.

21. The method of claim 20, wherein a vehicle in need of refueling is further notified of the status of at least one of the following parameters: time left before the vehicle runs out of hydrogen; an indication of whether the closest refueling station is available or busy; or an indication of the availability of fuel at the closest fueling station.

22. The method of claim 14, further comprising:
determining whether an operator of a vehicle that has been notified of a refueling opportunity has chosen not to refuel the vehicle.

23. The method of claim 22, further comprising:
recalculating the fuel benefit criterion or urgency for each vehicle in the fleet if an operator of a vehicle that has been notified of a refueling opportunity has chosen not to refuel the vehicle.

24. The method of claim 22, wherein it is determined that an operator of a vehicle that has been notified of a refueling opportunity has chosen not to refuel the vehicle when the operator fails to respond to the notification within a fixed time period.

25. The method of claim 22, wherein it is determined that an operator of a vehicle that has been notified of a refueling opportunity has chosen not to refuel the vehicle based on the locational tracking information provided by the vehicle.

26. The method of claim 14, further comprising:
calculating a predictor for forecasting hydrogen demand; and
using the predictor to manage the operating state of the one or more hydrogen plants.

27. The system of claim 1, wherein the fleet of vehicles comprises at least one vehicle selected from the group of transit or shuttle buses, taxis, trucks, and passenger vehicles.

28. A system for managing hydrogen fueling of a fleet of vehicles, comprising: a wireless network and a central processor;
wherein the central processor (i) collects data from each vehicle in the fleet of vehicles, (ii) collects data from one or more hydrogen fueling stations available to the fleet, (iii) calculates a fuel benefit criterion or urgency for each vehicle in the fleet, (iv) identifies and ranks vehicles in the fleet according to the fueling benefit criterion or urgency, and (v) notifies vehicles in the fleet of refueling opportunities according to ranking.
